(19) United States
(12) Patent Application Publication
(10) Pub. No.: US 2003/0055885 A1
(43) Pub. Date: Mar. 20, 2003

(54) Client instant information service system and method

(76) Inventors: Kuang-Shin Lin, Taipei (TW); Sayling Wen, Taipei (TW); Dong-Tong Xie, Tianjin (CN)

Correspondence Address: BIRCH STEWART KOLASCH & BIRCH, PO BOX 747, FALLS CHURCH, VA, 22040-0747, US

(21) Appl. No.: 10/193,095

(22) Filed: Jul. 12, 2002

(30) Foreign Application Priority Data
Aug. 3, 2001 (TW) 90118956

(51) Int. Cl. G06F 15/16

(52) U.S. Cl. 709/203; 709/218

(57) ABSTRACT

A client instant information service system and method is disclosed. The invention is a utility that can be operated with different OSs. The client/user only needs to execute one signal action to complete a given operation through the UOI (User Operating Interface) provided by the invention. The invention can also perform content updating, downloading, and browsing by instantly informing the client/user of any change on the server to achieve the purpose of real-time information/data transmission. The disclosed method includes the steps of: calling the interface generation module to generate user interfaces by the procedure control unit, calling the operation response module based on input messages of the client/user, calling the real-time data module to perform procedures and receiving an EXIT request from the client/user.

### BACKGROUND OF THE INVENTION

1. Field of the Invention

The invention relates to an operating system, which, specifically, is a client services system and method, with real-time information service functions, that can be operated with different OSs (Operating Systems).

2. Related Art

With the increase in computer popularity, people often need to use computers to solve problems either at work or at home. But there are some causes that still produce the difficulty for people to use computer especially in searching, getting, and reading real-time information people needed. One can see the causes in the following points:

1. Existing personal computer OSs (Operating Systems), such as MS Windows or Linux, are too complicated despite of their powerful functions and designs. Moreover, user interface designs are not intuitive and simple enough, so they scare those who are without any computer background or skills because of the obstacles involved in operating these systems.

2. Searching for information over a network may costs too much time. Because people seldom know when the information found will update, they have to spend much time on searing again then replace the one of old version.

Because of the above, it is thus highly desirable to provide a simple and convenient OS that could notice the user to get a real-time information over a network to update the one of old version in her/his computers right away.

### SUMMARY OF THE INVENTION

In view of the foregoing, the invention provides an instant information service system and its method for clients/users. The system is based on the One-Touch OS. Major objectives of the disclosed system are as follows:

1. to provide a finite number of keys as hot keys to achieve the operation of various functions, so that these functions can be initiated by one single key and provide convenient and intuitive operation in order to increase clients/users' interests in using the computer;

2. to save the updated information when the One-Touch OS is used for the first time, so that the client/user can browse updated contents on his/her own computer. Moreover, the client/user can download and update information from the provided Web, which is designed for specified user groups, to have the latest information and even to update programs, instead of searching information/data from a number of Web sites.

3. to inform the client/user in a timely fashion when any content is being updated, i.e., once the client/user sets her/his favorite contents on “instant notice” status, those clients/users who request this function will be informed of content changes or updates, instead of searching the Web from time to time on her/his own initiative.

The invention is mainly designed for those who have no computer background or skills to provide a simple and intuitive User Operating Interface (UOI) and system that can be operated with a co-existing OS, so as to make one computer with a dual-OS on it.

The invention, a client instant information service system, based on the above-mentioned features, facilitates information access, provides extra value for computers, and further promotes clients'/users' sales.

The disclosed client instant information service method includes at least the following steps: calling the interface generation module to generate a user interface through the procedure control unit, receiving a message from the client/user to call the operation response module, selecting the function options to initiate various procedures through the real-time data module, and receiving a request from the user to exit the client instant information service system.

### BRIEF DESCRIPTION OF THE DRAWINGS

The invention will become more fully understood from the detailed description given herein below. However, the following description is for purposes of illustration only, and thus is not limitative of the invention, wherein:

FIG. 1 shows a system structure of the disclosed client instant information service system;

FIG. 2 shows a function structure of the real-time data module based on the disclosed client instant information service system and its method;

FIG. 3-a shows a flowchart of the main function options under the procedure control unit within the real-time data module based on the disclosed client instant information service system and its method;

FIG. 3-b shows a flowchart of the browse function according to the disclosed client instant information service system and its method;

FIG. 3-c shows a flowchart of the download and update functions according to the disclosed client instant information service system and its method;

FIG. 3-d shows a flowchart of the “instant notice” request function according to the disclosed client instant information service system and its method;

FIG. 3-e shows a flowchart of the Web function according to the disclosed client instant information service system and its method;

FIG. 4 shows the main frame of the instant information function of the disclosed client instant information service system and its method;

FIG. 5 shows the main frame of the instant information update function according to the disclosed client instant information service system and its method; and

FIG. 6 shows the main menu of the disclosed client instant information service system and its method on the One-Touch OS.

### DETAILED DESCRIPTION OF THE INVENTION

The invention proposes a client instant information service system and its method. In particular, it provides a simple and intuitive UOI (User Operating Interface) as an alternative for the currently complicated OSs. The client/user is able to complete any operation by simply pressing one single hot key. Through a network connection, the client/user can use the One-Touch OS to perform real-time content browsing, transferring and updating.

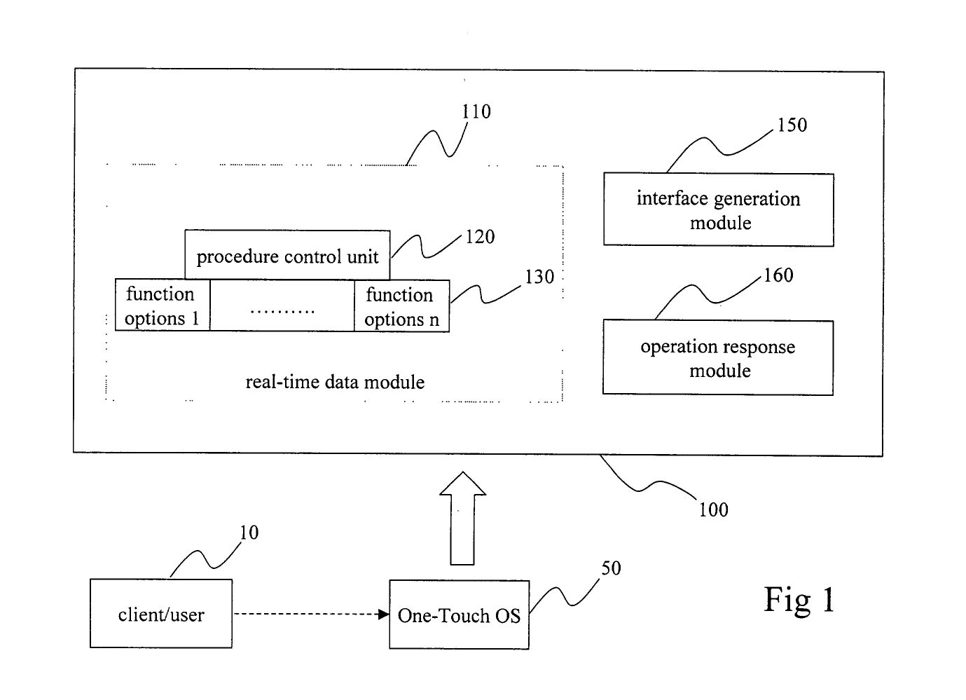

A preferred embodiment is provided below to explain the feasibility of the invention. With reference to FIG. 1, the disclosed client instant information service system 100 can generate different UOIs (User Operating Interfaces), and perform real-time content browsing, transferring and updating on the One-Touch OS 50. When the client/user 10 enters the client instant information service system 100 provided by the One-Touch OS 50, the system 100 will start to operate procedures including: (1) the real-time data module 110; (2) the interface generation module 150; and (3) the operation response module 160.

1. The real-time data module 110 containing the procedure control unit 120 is used to gather all received messages.

The procedure control unit 120 containing several function options 130 is used to generate relevant procedures according to received messages from the client/user.

The function options 130 contain various function procedures to be executed within the real-time data module 110.

2. The interface generation module 150 generates different function menus of the UOI (User Operating Interface) for the client/user to operate the system.

3. The operation response module 160 receives transferred messages among different clients/users and the server, and responds by calling various units and modules from other systems/programs.

The above-mentioned One-Touch OS 50 refers to an OS with a specific UOI (User Operating Interface) displayed on the screen, which is executed by the interface generation module 150 that enables the client/user 10 to complete functions provided in the work group with one action. The work group is comprised of more than one function option. The one-touch OS 50 can exist with other OSs or operate alone. The client/user can choose to switch between the different OSs on demand.

The above-mentioned real-time data module 110 provides several function options 130 under the procedure control unit 120, which generates various function procedures based on received messages from the client/user.

The one-touch OS 50 can be operated on any computer controlled hardware platform, such as a PC (Personal Computer), a NB (Notebook or laptop), or a PDA (Personal Digital Assistant). Any individual skilled in the art can make various modifications to implement the disclosed client instant information service system 100 in any electronic device that can establish communication with a network.

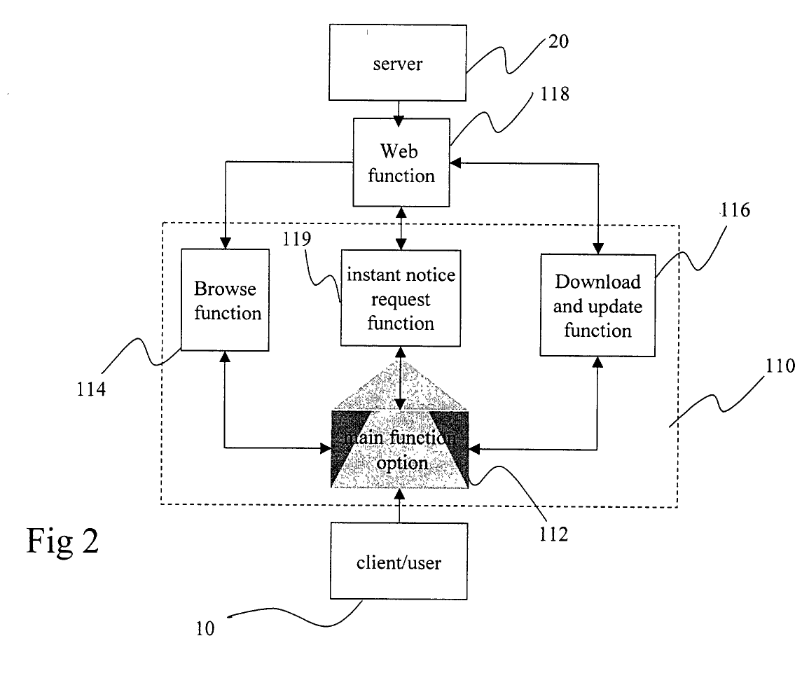

With reference to FIG. 2, the function structure of the real-time data module of the disclosed client instant information service system and its method involves the client/user 10 selecting the browse function 114, the download and update function 116, or the “instant notice” request function 119 by means of the main function option 112 to perform the real-time transmission of information/data, as well as to establish connection with the server 20 by way of the Web function 118. The detailed operations are as follows.

The main function option 112 for the user is the same as the procedure control unit 120 for the disclosed client instant information service system and its method. The Web function 118 is on the server 20 end to execute messages received from the client/user 10, whereas the browse function 114 is on the client/user 10 end to read contents displayed on the One-Touch OS 50. The download and update function 116 instantly downloads contents from the server 20 and updates the application programs to the client/user 10. Moreover, the “instant notice” request function 119, based on stored contents of the client/user, transfers messages when there is relevant contents from the server 20 to the client/user 10.

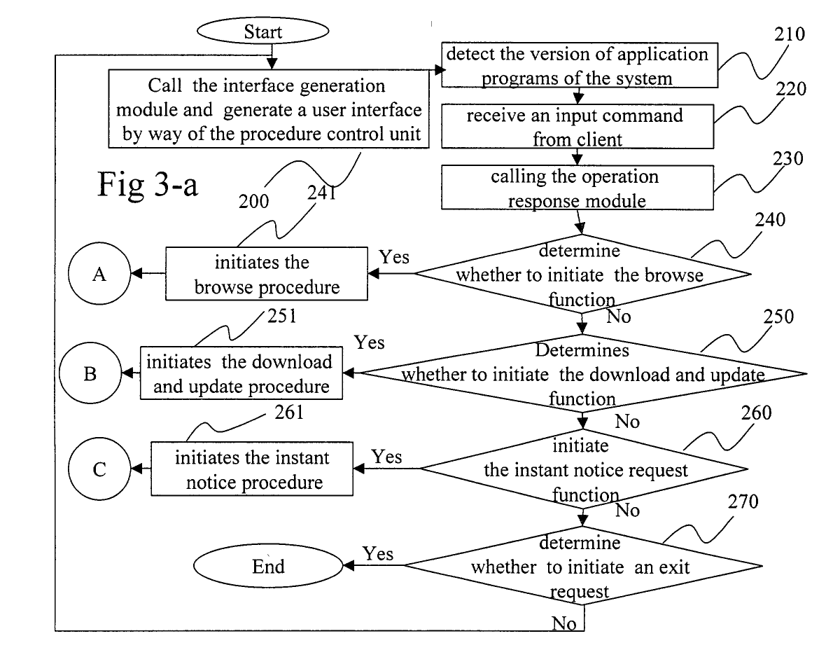

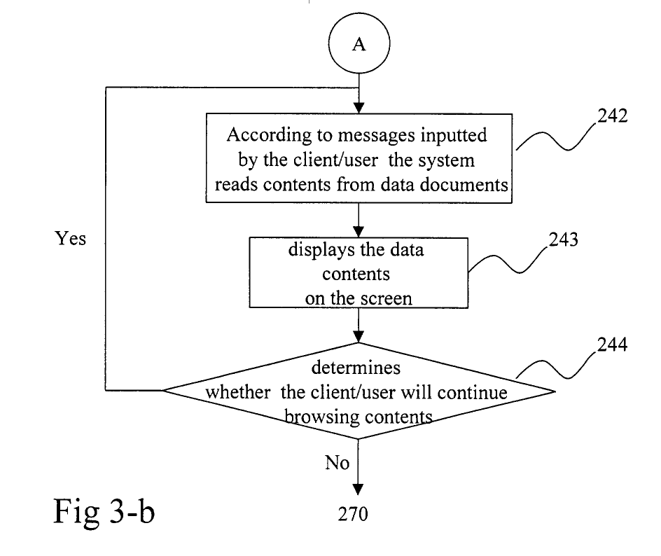

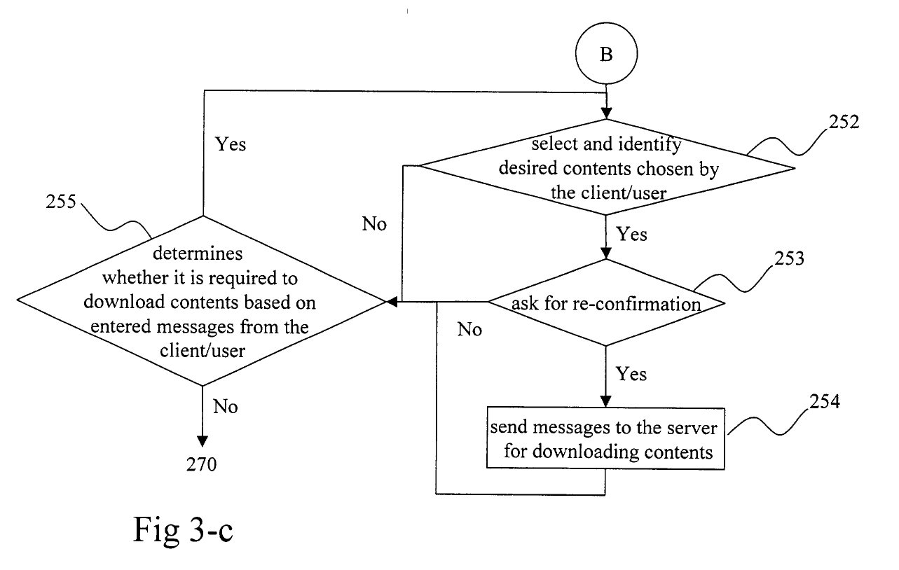

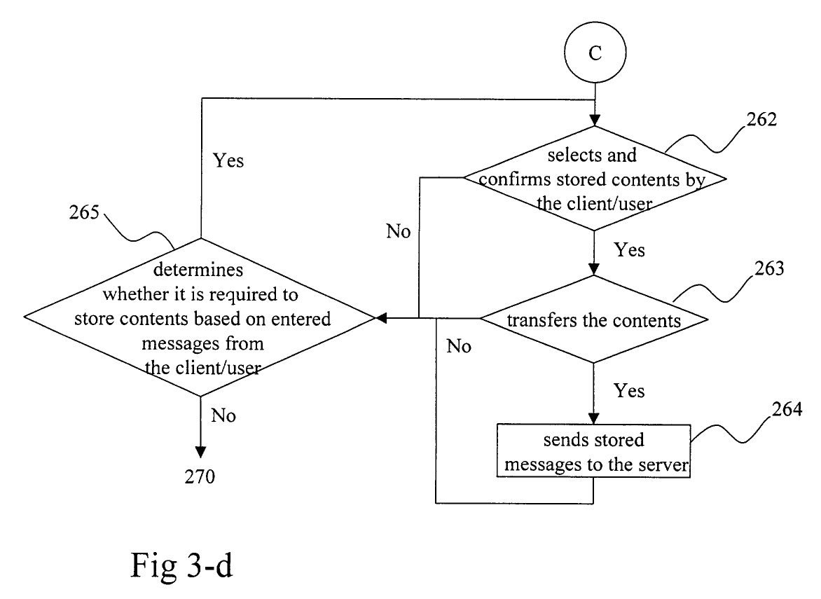

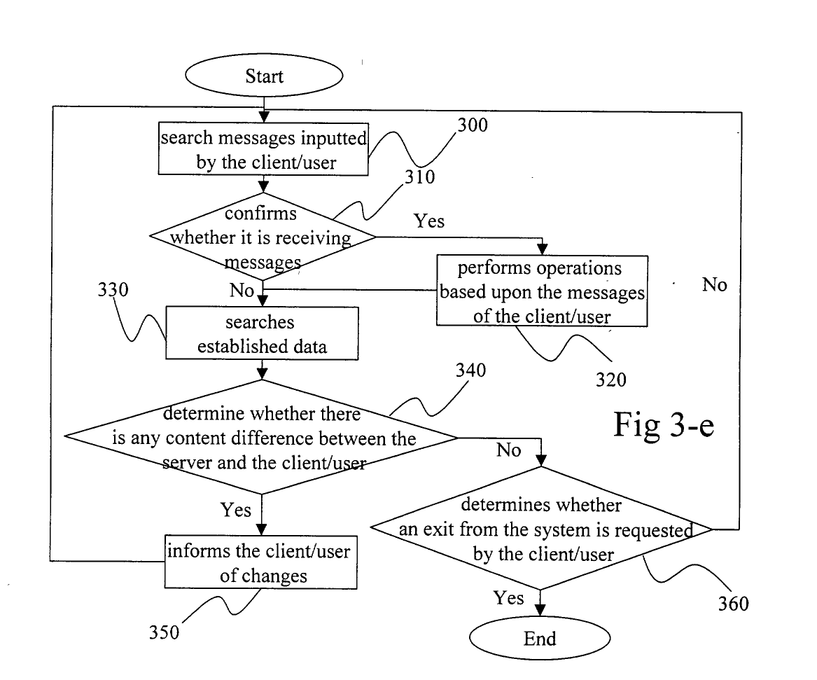

FIG. 3-a is a flowchart of the main function options of the procedure control unit within the real-time data module of the disclosed client instant information service system and its method. It represents the detailed flow of the main function option 112 as follows.

Once the client/user 10 enters the disclosed client instant information service system 100, the system 100 will initiate the interface generation module 150 and generate a user interface by way of the procedure control unit 120 (step 200), which provides a specific UOI (User Operating Interface) of the One-Touch OS. Also, the system 100 will detect the version of application programs of the system 100 (step 210). After reading the version, the system will receive an input command (step 220), which is operated by a function menu displayed on the UOI (User Operating Interface) of the system to the client/user 10. When a user command is received, the system calls the operation response module 160 (step 230) to determine whether to initiate the browse function 114 (step 240). If so, it initiates the browse procedure (step 241) and goes to the process symbol A. Otherwise, the system determines whether to initiate the download and update function 116 (step 250). If required, the system initiates the download and update procedure (step 251) and goes to the process symbol B. If not, the system determines whether to initiate the “instant notice” request function 140 (step 260). If so, it initiates the “instant notice” procedure (step 261) and goes to the process symbol C. In addition to all the above conditions, the system will determine whether to initiate an EXIT request (step 270) to terminate the function flow, or go to (step 200) instead.

FIG. 3-b, which is a flowchart of the browse function of the disclosed client instant information service system and its method, represents the steps of process symbol A that are executed in step 241.

According to messages inputted by the client/user 10, the system reads contents from data documents (step 242), the operation response module 160 identifies desired contents selected by the client/user 10, which are saved on storage devises of any computer controlled hardware platform by the client/user 10, and displays the data contents on the screen (step 243). After the contents are browsed based on entered messages from the client/user 10 (step 220), the system determines whether the client/user will continue browsing contents (step 244). If so, the system goes back to step 242, or goes to step 270 instead.

FIG. 3-c, which is a flowchart of the download function of the disclosed client instant information service system and its method, represents the steps of process symbol B that are executed in step 251.

According to messages entered by the client/user 10, the system 100 will select and identify desired contents chosen by the client/user 10 (step 252) to confirm download condition, then ask for re-confirmation (step 253). If confirmed, the system then sends messages to the server 20 for downloading contents (step 254). Otherwise, the system 100 determines whether it is required to download contents based on entered messages from the client/user 10 (step 255). If so, it goes back to step 252, or goes to step 270 instead. The download function 116 detects the version of application programs of the system (step 210) and enables the system to upgrade outdated versions. Any downloaded programs and contents can be quickly stored onto storage devices through the One-Touch OS 50.

FIG. 3-d, which is a flowchart of the “instant notice” request function of the disclosed client instant information service system and its method, represents the steps of process symbol C that are executed in step 261.

According to messages inputted by the client/user 10, the system 100 selects and confirms stored contents by the client/user 10 (step 262). If confirmed, it transfers the contents (step 263), then sends stored messages to the server 20 (step 264). The system 100 determines whether it is required to store contents based on entered messages from the client/user 10 (step 265). If so, it goes back to step 262, or goes to step 270 instead.

FIG. 3-e, which is a flowchart of the Web function of the disclosed client instant information service system and its method, represents the detailed flow of the Web function 118 as follows,

The system 100 first begins to search messages inputted by the client/user 10 (step 300), then confirms whether it is receiving messages (step 310). If so, it performs operations based upon the messages of the client/user 10 (step 320). For the execution of procedures refer to FIGS. 3-a, 3-b, 3-c and 3-d. The system 100 then searches established data (step 330) and informs those client/users 10 who set the established data on “instant notice” status of any system change or update. This is in lieu of the clients/users 10 updating the Web from time to time by themselves. Afterwards, the system 100 will determine whether there is any content difference between the server and the client/user (step 340). If there is, it informs the client/user 10 of changes (step 350) and goes to the process in FIG. 3-c to perform download and update functions. Otherwise, the system 100 determines whether an EXIT from the system is requested by the client/user 10 (Step 360). If it is, then the procedure ends, or the system goes to step 300 instead.

The above-mentioned main function options 112 control each procedure unit to execute different functions, such as the browse function 114, the download and update function 116 and the “instant notice” request function 119. The Web function 118 is on the server 20 end, whereas all downloaded and updated contents are stored on the client/user 10 end, where all functions can be performed with one single action through the client instant information service system and its method of the One-Touch OS 50.

According to FIGS. 3-a to 3-e, the invention can be executed by one single action. Furthermore, the interface generation module 150 generates a UOI (User Operating Interface) to provide the client/user 10 with a display menu on screen to select and operate specific function processes of FIGS. 3-a to 3-e.

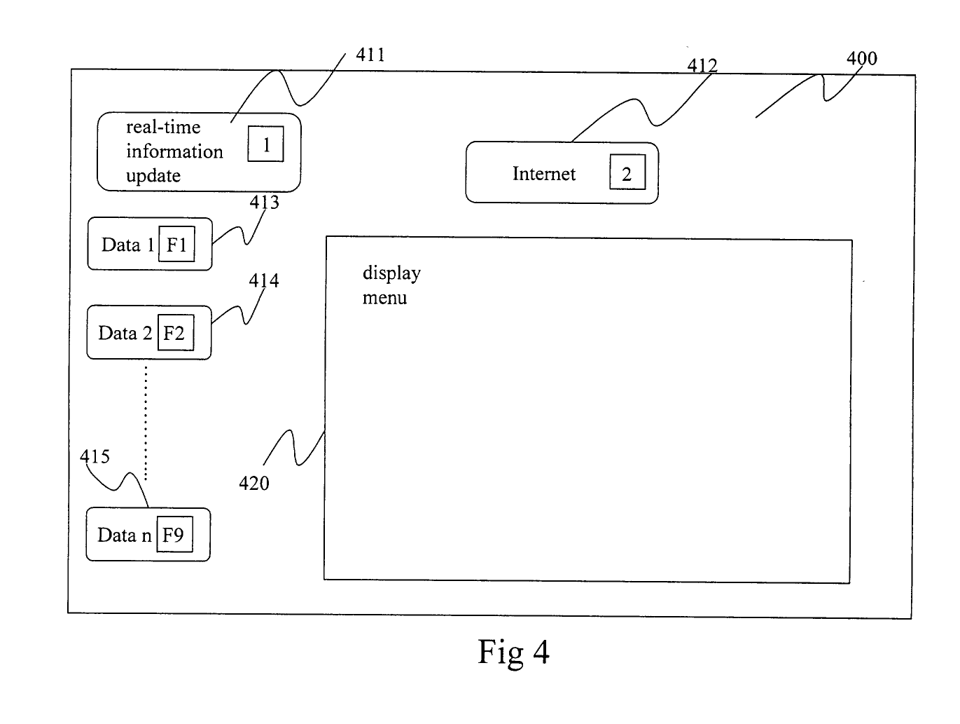

As shown in FIG. 4, the main frame of the instant information function of the disclosed client instant information service system and its method enables the client/user 10 to enter and follow the instant information interface window 400 to select desired function options. The display menu 411 allows the client/user 10 to perform real-time information update functions in one single action by pressing “1” to save contents on storage devices, or “F2” to use the display menu 414. That is, the client/user 10 does not need to do extra actions of setting up the system and saving files. Instead, s/he need press only one key to perform a specific task. Therefore, the client/user 10 can enjoy computer functions in a more intuitive way, to increase interest in those who are not familiar with computers.

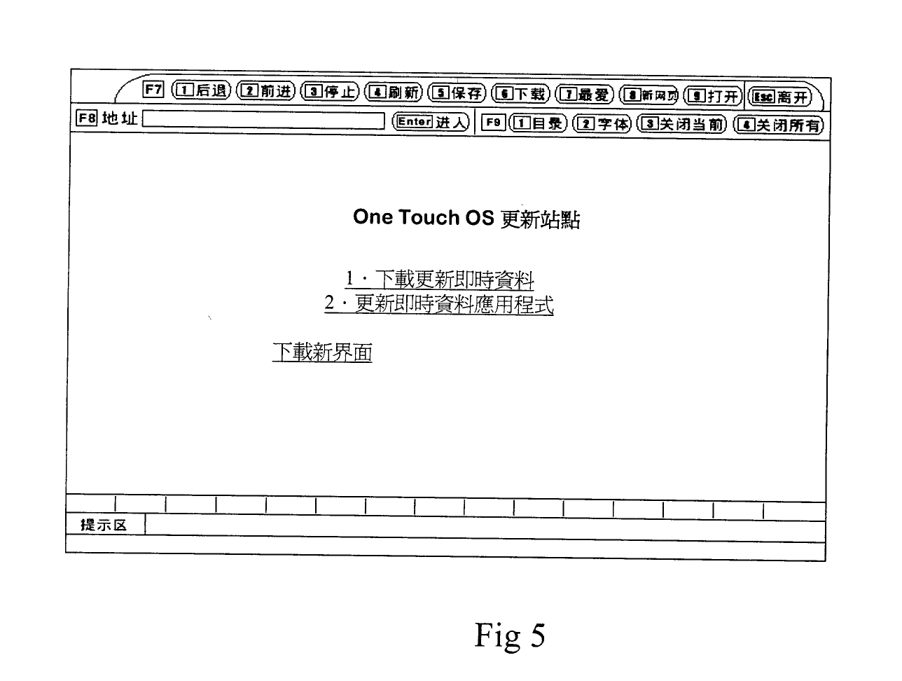

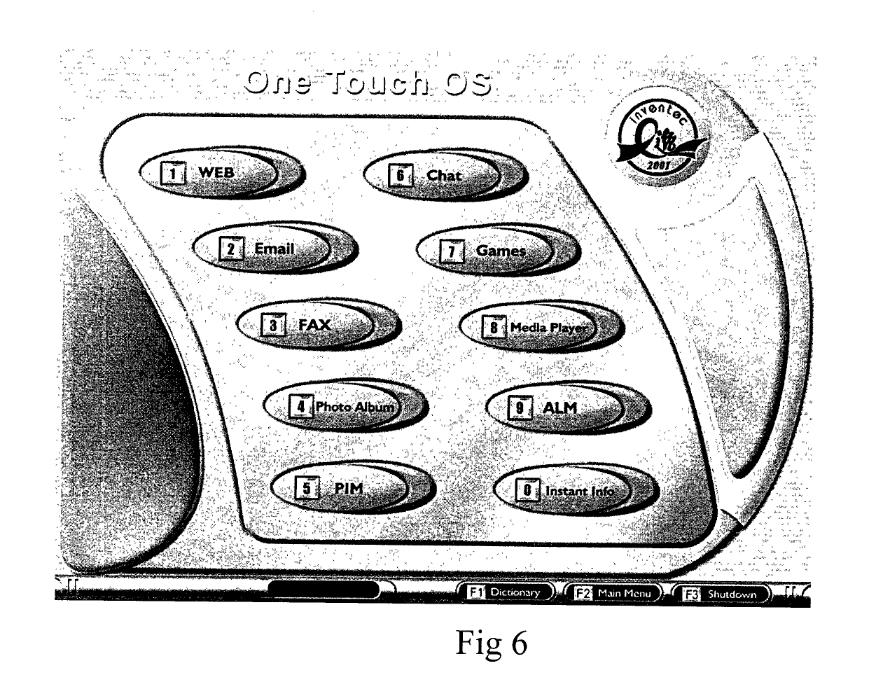

FIGS. 5 and 6 respectively show the main frame of the instant information update function of the disclosed client instant information service system and its method, and the main menu of the disclosed client instant information service system and its method on the One-Touch OS.

The above illustrations show that the client/user 10 can perform all these functions with one single action, and the UOI (User Operating Interface) provides more than one display menu, which enables the client/user 10 to input messages and operate required functions with “one single action”. The “one single action” provided by the one-touch OS 50 enables the client/user 10 to press one key of the keyboard according to an on-screen display menu to operate various functions. Any key on the keyboard, including the number keys 0˜9, the letter keys A˜Z, the function keys F1˜F12 and special keys, such as ESC, TAB, PgUp, END, can be used to perform various functions. Aside from the keyboard, the single action operation can be accomplished by clicking a mouse or other controllers, such as a digital touch-control panel, or a voice recognition system. That is, any basic I/O (Input/Output) device can be used to perform one-touch control.

The invention in the form of the client instant information service system and its method of use has been described herein. These and other variations, which will be understood by those skilled in the art, are intended to be within the scope of the invention as claimed below. As previously stated, detailed embodiments of the invention are disclosed herein; however, it is to be understood that the disclosed embodiments are merely exemplary of the invention that may be embodied in various forms.

What is claimed is:

1. A client instant information service system is used on the One-Touch OS (Operating System) on a computer controlled hardware platform for real-time information/data transmission, and the system provides a through monitor while connecting the client/user with the server to accomplish real-time content update and transmission. The client instant information service system, at least comprises:
a real-time data module, which gathers all received messages and further includes:
a procedure control unit, which generates relevant procedures to reflect different information requests. The procedure control unit further includes:
a function option, which analyses received message format to generate respective signals;
an interface generation module, which provides the client/user 10 with various UOI (User Operating Interface) of displayed menus for operation;
an operation response module, which processes messages both received from the client/user 10 and sent out by the server 20, moreover, according to respective messages, calls and executes various units or modules through another programs/systems; and

2. The system of claim 1, wherein the one-touch OS is an OS that enables the user to complete a function provided in the work group displayed in a UOI (User Operating Interface) with one single action.

3. The system of claim 2, wherein the work group comprises of more than one function options.

4. The system of claim 2, wherein the one single action refers to the action that the client/user follows a displayed menu generated by the interface generation module to perform using a basic I/O (Input/Output) device provided by the computer controlled hardware platform.

5. The system of claim 4, wherein the basic I/O (Input/Output) device is selected from the group comprising a keyboard, a mouse, a digital touch-control panel and a voice recognition system.

6. The system of claim 1, wherein the one-touch OS can be operated with other different OSs and the user determines to switch among the different OSs.

7. The system of claim 1, wherein the real-time data module provides several function options under the procedure control unit, which generates various function procedures based on received messages from the client/user.

8. The system of claim 1, wherein the real-time data module further includes,
a main function option, which stores an “instant notice” status on the client/user, which status upon request enables instant information update to the client/user where there is any changes from the server.
a browse function, which enables the client/user to search and browse contents through displayed screen of the One-Touch OS.
a download and update function, which enables instant contents downloaded and application programs updated from the server to the client/user.
an “instant notice” request function, which enables instant notice to the client/user according to stored contents on the client/user once there is relevant content changes from the server.
a Web function, which is on the server side to process messages transferred by the client/user.

9. The system of claim 1, wherein a computer controlled hardware platform is selected from the group comprising a keyboard, a mouse, a digital touch-control panel and a voice recognition system.

10. A client instant information service system and its method is used on the One-Touch OS (Operating System) for real-time information(data) transmission through established communications between the client/user and the server to accomplish instant content update and browse. The method at least comprises the steps of:
calling an interface generation module and generating a user interface through a procedure control unit;
receiving messages from the client/user;
calling an operation response module according to the user messages;
calling a real-time data module to select procedures based on the user messages; and
receiving an EXIT request.

11. The method of claim 10, wherein the steps of selecting procedures through calling a real-time data module further comprises:
a main function option module;
a browse function;
a download and update function;
an “instant notice” request function; and
a Web function.

12. The method of claim 11, wherein the main function option for processing messages further comprises the steps of:
evaluating if the message is a command;
detecting the version of application programs; and
going to the download function.

13. The method of claim 12, wherein the command is for real-time informing the client/user of content changes from the server upon instant notice request by the client/user.

14. The method of claim 11, wherein the browse function for processing messages further comprises the steps of:
according to received messages from the client/user to read contents from a data document;
displaying the contents; and
evaluating if continuous browse is requested.

15. The method of claim 14, wherein the data document is stored on storage devices provided by the computer controlled hardware platform.

16. The method of claim 11, wherein the download and update function for processing messages further comprises the steps of:
selecting and identifying downloaded contents;
sending messages to the server asking for downloading; and
evaluating if continuous downloading content is requested.

17. The method of claim 16, wherein the downloaded contents are stored on the server.

18. The method of claim 11, wherein the “instant notice” request function for processing messages further comprises the steps of:
selecting and identifying/confirming stored contents;
sending messages to the server for stored contents; and
evaluating if continuous storing content is requested.

19. The method of claim 11, wherein the Web function for processing messages further comprises the steps of:
searching message sent by the client/user;
confirming messages are received;
processing the client/user's request;
searching for setting status of the client/user;
contrasting content change status; and
informing the client/user of content changes.

20. The method of claim 11, wherein the main function option, the browse function, the download and update function, and the Web function are under monitor and control of the One-Touch OS, which enables to complete all functions or commands with one single action.

21. The method of claim 20, wherein one single action refers to displayed menus, which are respectively generated by the interface generation module, to perform using a basic I/O (Input/Output) device provided by the computer controlled hardware.

22. The system of claim 21, wherein basic I/O (Input/Output) device is selected from any of the groups, such as a keyboard, a mouse, a digital touch-control panel and a voice recognition system.
